(19) United States
(12) Patent Application Publication
(10) Pub. No.: US 2020/0227789 A1
(43) Pub. Date: Jul. 16, 2020

(54) ALL SOLID STATE BATTERY

(71) Applicant: TOYOTA JIDOSHA KABUSHIKI KAISHA, Toyota (JP)

(72) Inventor: Yoshitaka MINAMIDA, Toyota-shi, Aichi-ken (JP)

(21) Appl. No.: 16/708,602

(22) Filed: Dec. 10, 2019

(30) Foreign Application Priority Data
Jan. 11, 2019 (JP) 2019-003207

(51) Int. Cl. H01M 10/0585; H01M 2/26

(52) U.S. Cl. CPC H01M 10/0585; H01M 2/26

(57) ABSTRACT

A main object of the present disclosure is to provide an all solid state battery in which both the improvement of uniformity of electrode reaction in a power generating element and inhibition of degrading in energy density are achieved. The present disclosure achieves the object by providing an all solid state battery comprising: a cathode current collector; a cathode tab connected to the cathode current collector; an anode current collector; an anode tab connected to the anode current collector; and a power generating element formed between the cathode current collector and the anode current collector; wherein the power generating element comprises a first power generating part, a second power generating part, and an insulating part; the first power generating part and the second power generating part respectively comprises a power generating unit including a cathode layer, a solid electrolyte layer, and an anode layer; the all solid state battery has bend structure in which the first power generating part and the second power generating part are stacked in a thickness direction due to a bend of the insulating part; both of the cathode tab and the anode tab are arranged at a same side of the all solid state battery; and when the bend structure is developed to a plan structure, the cathode tab and the anode tab are located in a diagonal relationship.

### TECHNICAL FIELD

The present disclosure relates to an all solid state battery.

### BACKGROUND ART

An all solid state battery is a battery including a solid electrolyte layer between a cathode layer and an anode layer, and one of the advantages thereof is that the simplification of a safety device may be more easily achieved compared to a liquid-based battery including a liquid electrolyte containing a flammable organic solvent.

Meanwhile, a battery includes a cathode tab and an anode tab in order to output current. Also, conventional batteries are broadly categorized into a one side tab structure and a both tab structure according to their positions of the tabs. For example, Patent Literature 1 discloses a battery having a one side tab structure in which the cathode tab and the anode tab are located at the same side. On the other hand, Patent Literature 2 discloses a battery having a both tab structure in which the cathode tab and the anode tab are located so as to oppose to each other.

### CITATION LIST

### Patent Literatures

Patent Literature 1: Japanese Patent Application Laid-Open (JP-A) No. 2018-129153

Patent Literature 2: JP-A No. 2004-031270

### SUMMARY OF DISCLOSURE

### Technical Problem

In the one side tab structure, degrade in energy density may be easily inhibited since there is not much dead space not contributing to generate power; however, the uniformity of electrode reaction in a power generating element is low. On the other hand, in the both tab structure, although the uniformity of electrode reaction in the power generating element is high, it is not easy to inhibit the degrade in energy density since there is much dead space not contributing to generate power.

The present disclosure has been made in view of the above circumstances, and a main object thereof is to provide an all solid state battery in which both the improvement of uniformity of electrode reaction in the power generating element and inhibition of degrade in energy density are achieved.

### Solution to Problem

In order to achieve the object, the present disclosure provides an all solid state battery comprising: a cathode current collector; a cathode tab connected to the cathode current collector; an anode current collector; an anode tab connected to the anode current collector; and a power generating element formed between the cathode current collector and the anode current collector; wherein the power generating element comprises a first power generating part, a second power generating part, and an insulating part; the first power generating part and the second power generating part respectively comprises a power generating unit including a cathode layer, a solid electrolyte layer, and an anode layer; the all solid state battery has bend structure in which the first power generating part and the second power generating part are stacked in a thickness direction due to a bend of the insulating part; both of the cathode tab and the anode tab are arranged in a same side of the all solid state battery; and when the bend structure is developed to a plan structure, the cathode tab and the anode tab are located in a diagonal relationship.

According to the present disclosure, the battery in which the cathode tab and the anode tab are located in the diagonal relationship is bent interposing the insulating part to have the bend structure so as to obtain the all solid state battery in which both the improvement of uniformity of electrode reaction in the power generating element and inhibition of degrade in energy density are achieved.

In the disclosure, a total of a width of the cathode tab and a width of the anode tab may be a width of the cathode layer or more.

In the disclosure, a total of a width of the cathode tab and a width of the anode tab may be a width of the anode layer or more.

In the disclosure, the power generating element may have a structure in which a plurality of the power generating unit is stacked in a thickness direction.

In the disclosure, the plurality of the power generating element may be connected to each other in parallel.

In the disclosure, the plurality of the power generating element may be connected to each other in series.

In the disclosure, when the bend structure is developed to a plan structure, a length of each of the insulating part in the plurality of the power generating element may increase along with the thickness direction.

### Advantageous Effects of Disclosure

The all solid state battery in the present disclosure exhibits an effect such that both the improvement of uniformity of electrode reaction in the power generating element and inhibition of degrade in energy density may be achieved.

### BRIEF DESCRIPTION OF DRAWINGS

FIG. 1 is a schematic cross-sectional view explaining the all solid state battery in the present disclosure.

FIGS. 2A and 2B are schematic perspective views explaining the all solid state battery in the present disclosure.

FIGS. 3A to 3C are schematic diagrams explaining the one side tab structure.

FIGS. 4A and 4B are schematic diagrams explaining the both tab structure.

FIGS. 5A to 5C are schematic cross-sectional views explaining the all solid state battery in the present disclosure.

FIGS. 6A and 6B are schematic plan views explaining the all solid state battery in the present disclosure.

FIGS. 7A and 7D are schematic cross-sectional views explaining the all solid state battery in the present disclosure.

FIGS. 8A and 8B are schematic cross-sectional views explaining the all solid state battery in the present disclosure.

FIGS. 9A and 9B are schematic cross-sectional views explaining the all solid state battery in the present disclosure.

FIGS. 10A to 10E are schematic cross-sectional views explaining an example of a method for producing the all solid state battery in the present disclosure.

### DESCRIPTION OF EMBODIMENTS

The all solid state battery in the present disclosure is hereinafter explained in details.

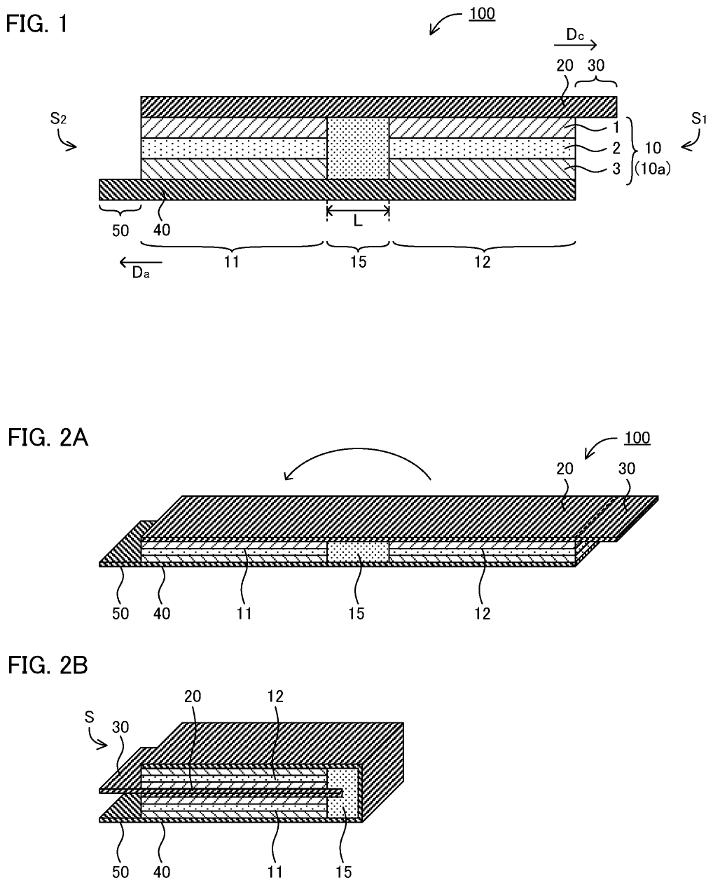

FIG. 1 is a schematic cross-sectional view explaining the all solid state battery in the present disclosure which shows a battery before forming the bend structure. Incidentally, the state before forming the band structure corresponds to, as described later, the state in which the bend structure is developed to a plan structure.

All solid state battery 100 shown in FIG. 1 comprises cathode current collector 20, cathode tab 30 connected to the cathode current collector 20, anode current collector 40, anode tab 50 connected to the anode current collector 40, and power generating element 10 formed between the cathode current collector 20 and the anode current collector 40. Further, the power generating element 10 comprises first power generating part 11, second power generating part 12, and insulating part 15. In FIG. 1 (when the bend structure is developed to a plan structure), the insulating part 15 is arranged between the first power generating part 11 and the second power generating part 12. Furthermore, the first power generating part 11 and the second power generating part 12 respectively comprises a power generating unit 10a including cathode layer 1, solid electrolyte layer 2, and anode layer 3.

Also, in FIG. 1 (when the bend structure is developed to a plan structure), the cathode tab 30 and the anode tab 50 are located in a diagonal relationship. The “diagonal relationship” refers to a relationship where one of the cathode tab and the anode tab is arranged at a first side of the all solid state battery, and the other of the cathode tab and the anode tab is arranged at a second side opposite to the first side. In FIG. 1, the cathode tab 30 is arranged at the first side S₁ of the all solid state battery, and the anode tab 50 is arranged at the second side S₂ opposite to the first side. Also, the diagonal relationship may be, as shown in FIG. 1, referred to as a relationship where the current direction D_{c} that flows from the cathode current collector 20 to the cathode tab 30 is opposite to the current direction Dₐ that flows from the anode current collector 40 to the anode tab 30. In the conventional both tab structure, the cathode tab and the anode tab are located in the diagonal relationship.

FIG. 2A shows an all solid state battery before forming the bend structure as in FIG. 1. As shown in FIG. 2A, while the first power generating part 11 is fixed, the second power generating part 12 is reversed with the insulating part 15 serving as a starting point. Thereby, as shown in FIG. 2B, the insulating part 15 is bent to form the bend structure in which the first power generating part 11 and the second power generating part 12 are stacked in the thickness direction. In this state, both of the cathode tab 30 and the anode tab 50 are arranged at the S side (same side) of the all solid state battery 100.

According to the present disclosure, the battery in which the cathode tab and the anode tab are located in the diagonal relationship is bent interposing the insulating part to have the bend structure so as to obtain the all solid state battery in which both the improvement of uniformity of electrode reaction in the power generating element and inhibition of degrade in energy density are achieved. In other words, the both tab structure is bent interposing the insulating part to form the one side tab structure so as to obtain the merits of the both tab structure and the one side tab structure while eliminating the demerits of the both structures.

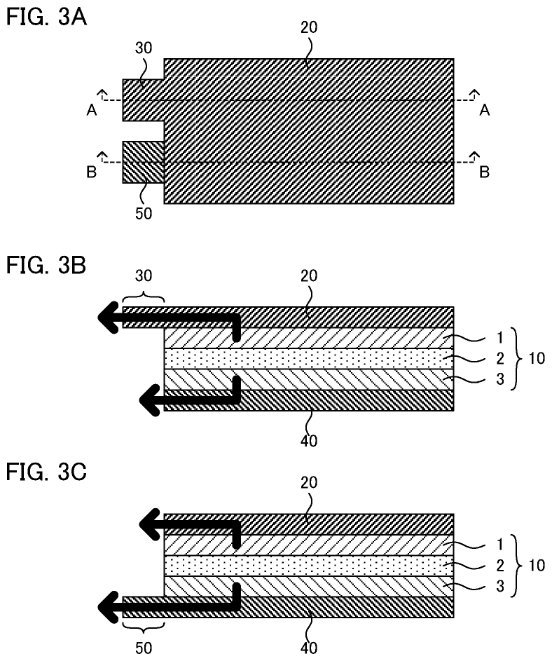

Here, FIG. 3A is a schematic plan view explaining the one side tab structure, FIG. 3B is the cross-sectional view of A-A line in FIG. 3A, and FIG. 3C is the cross-sectional view of B-B line in FIG. 3A. As shown in FIG. 3A, in the one side tab structure, both of the cathode tab 30 and the anode tab 50 are arranged at the same side of the all solid state battery. One of the merits in the one side tab structure is that the degrade in energy density may be restrained to minimum since the dead space not contributing to generate power is generated in only one side of the battery. On the other hand, one of the demerits of the one side tab structure is that the uniformity of electrode reaction in the power generating element is low.

In specific, as shown in FIGS. 3B and 3C, the electrode reaction occurs with priority in the side where the cathode tab 30 and the anode tab 50 are present, and thus the uniformity of electrode reaction in the power generating element becomes low. When the uniformity of electrode reaction is low, the region where the electrode reaction occurs with priority is easily deteriorated, but the region where the electrode reaction does not occur with priority is not easily deteriorated; thus, there is a possibility that the performance of the power generating element may not be sufficiently utilized. In particular, when charge and discharge are carried out at a high rate, the uniformity of electrode reaction tends to be low. Also, temperature in the region where the electrode reaction occurs with priority easily rises, but temperature in the region where the electrode reaction does not occur with priority does not easily rise. The higher the temperature is, the more the electrode reaction is activated; thus, there is a possibility that the ununiformity of the electrode reaction may be accelerated.

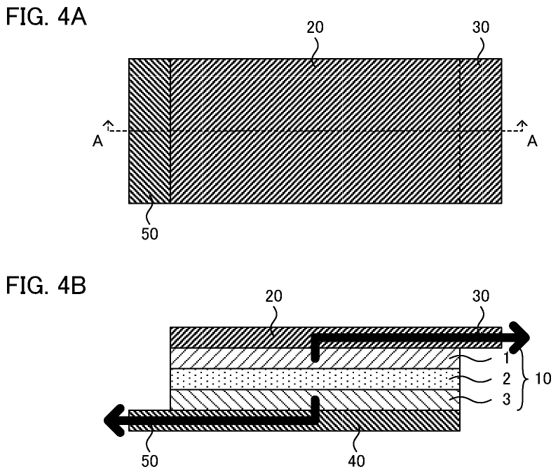

FIG. 4A is a schematic plan view explaining the both tab structure, and FIG. 4B is the cross-sectional view of A-A line in FIG. 4A. As shown in FIG. 4A, in the both tab structure, the cathode tab 30 and the anode tab 50 are arranged so as to oppose to each other. As shown in FIG. 4B, one of the merits in the both tab structure is that the uniformity of electrode reaction in the power generating element is high since the cathode tab 30 and the anode tab 50 are located in the diagonal relationship. On the other hand, one of the demerits in the both tab structure is that the degrade in energy density is not easily inhibited since the dead space not contributing to generate power is generated in both sides of the battery.

To solve the problem, the all solid state battery in the present disclosure has a structure such that the battery in which the cathode tab and the anode tab are located in the diagonal relationship is bent interposing the insulating part, so as to allow the all solid state battery to achieve both the improvement of uniformity of electrode reaction in the power generating element (merit of the both tab structure) and inhibition of degrade in energy density (merit of the one side tab structure).

1. Constitution of All Solid State Battery

The all solid state battery in the present disclosure comprises a cathode current collector, a cathode tab connected to the cathode current collector, an anode current collector, an anode tab connected to the anode current collector, and a power generating element formed between the cathode current collector and the anode current collector.

The power generating element comprises a first power generating part, a second power generating part, and an insulating part. Further, the first power generating part and the second power generating part respectively comprises a power generating unit including a cathode layer, a solid electrolyte layer, and an anode layer. In the first power generating part and the second power generating part, it is preferable that the kind of the constituents of the cathode layer (such as a cathode active material) and the proportion of the constituents are the same. For example, when the cathode layer in the first power generating part and the cathode layer in the second power generating part are continuously formed using the same composition (such as slurry), in the first power generating part and the second power generating part, the kind of the constituents of the cathode layer and the proportion of the constituents are the same.

Also, in the first power generating part and the second power generating part, the thickness of the cathode layer may be the same and may be different; however, it is preferable that the thickness of the cathode layers are the same to the extent that allows the uniformity of the electrode reaction to be maintained. The difference in the thickness is, for example, 10 μm or less, may be 5 μm or less, and may be 1 μm or less.

In the same manner, in the first power generating part and the second power generating part, it is preferable that the kind of the constituents of the anode layer (such as an anode active material) and the proportion of the constituents are the same. Also, in the first power generating part and the second power generating part, the thickness of the anode layer may be the same and may be different; however, it is preferable that the thickness of the anode layers are the same to the extent that allows the uniformity of the electrode reaction to be maintained. The difference in the thickness is, for example, 10 μm or less, may be 5 μm or less, and may be 1 μm or less. Likewise, in the first power generating part and the second power generating part, it is preferable that the kind of the constituents of the solid electrolyte layer (such as a solid electrolyte) and the proportion of the constituents are the same. Also, in the first power generating part and the second power generating part, the thickness of the solid electrolyte layer may be the same and may be different; however, it is preferable that the thickness of the solid electrolyte layers are the same to the extent that allows the uniformity of the electrode reaction to be maintained. The difference in the thickness is, for example, 10 μm or less, may be 5 μm or less, and may be 1 μm or less.

Also, the all solid state battery in the present disclosure has bend structure in which the first power generating part and the second power generating part are stacked in the thickness direction due to a bend of the insulating part. In specific, as shown in FIG. 2B, the first power generating part 11 and the second power generating part 12 are stacked in the thickness direction. In the bend structure, the insulating part 15 is present in a bent state. Also, it is preferable that the insulating part 15 contacts with the end of the first power generating part 11 and the end of the second power generating part 12.

Also, in FIG. 2A, the cathode current collector 20 is continuously formed with respect to the first power generating part 11, the insulating part 15, and the second power generating part 12. Accordingly, in FIG. 2B, bent insulating part 15 includes a part of the cathode current collector 20. In this manner, it is preferable that the bent insulating part includes a part of the cathode current collector or the anode current collector. Incidentally, in FIG. 2A, the anode current collector 40 is also continuously formed with respect to the first power generating part 11, the insulating part 15, and the second power generating part 12.

Also, as shown in FIG. 1, when the bend structure is developed to a plan structure, the length of the insulating part is determined as L. There are no particular limitations on the value of L; for example, it is 1 mm or more, and may be 1 cm or more. Meanwhile, the value of L is, for example, 5 cm or less, and may be 2 cm or less. Also, when the bend structure is formed, the value of L/2 is preferably smaller than the length of the cathode tab or the length of the anode tab so that the volume efficiency improves more compared to the conventional both tab structure.

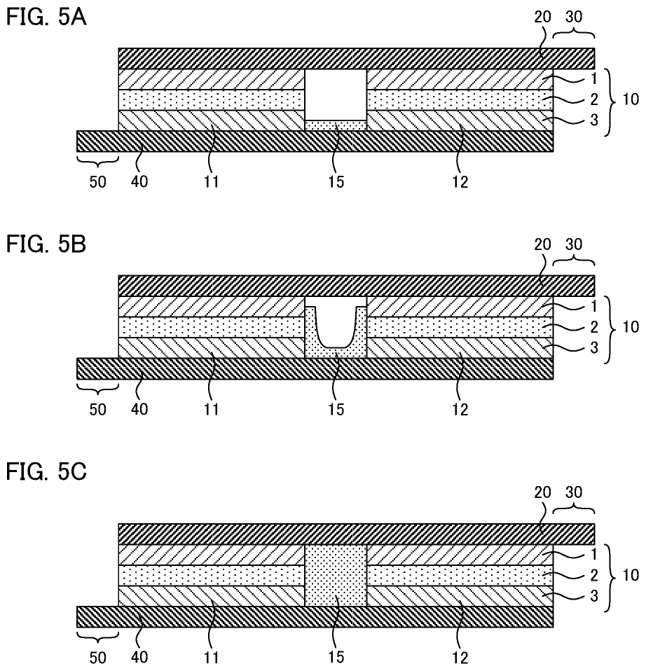

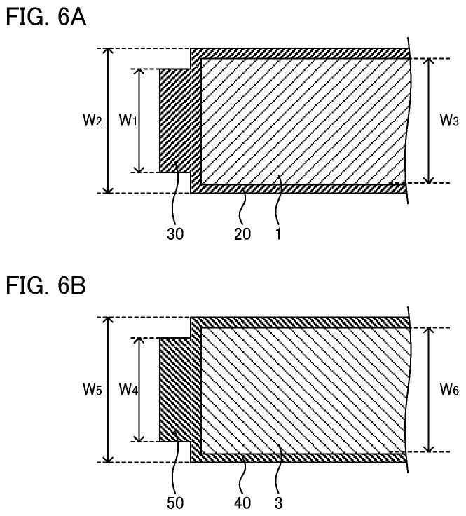

The insulating part is a region for insulating the cathode current collector and the anode current collector. The insulating part usually contains an insulating material. Examples of the insulating material may include a resin such as polyimide, rubber, and ceramic. The insulating part is formed so as to insulate the cathode current collector and the anode current collector. For example, in FIG. 5A, insulating part 15 is formed on the surface of anode current collector 40, and there is a void between the insulating part 15 and the cathode current collector 20. In this manner, the insulating part may be formed on the surface of at least one of the cathode current collector and the anode current collector, and a void may be generated between the insulating part and a current collector facing thereto.

Also, in FIG. 5B, the insulating part 15 is formed on the whole surface of the end of anode layer 3 in the first power generating part 11, and the whole surface of the end of the anode layer 3 in the second power generating part 12. In this way, short circuits of the first power generating part 11 and the second power generating part 12 may be prevented. In this manner, the insulating part may be formed on the whole surface of the end of the anode layer in the first power generating part, and the insulating part may be formed on the whole surface of the end of the anode layer in the second power generating part. Likewise, the insulating part may be formed on the whole surface of the end of the cathode layer in the first power generating part, and the insulating part may be formed on the whole surface of the end of the cathode layer in the second power generating part.

Also, in FIG. 5C, the insulating part 15 is formed to fill in the space between the first power generating part 11 and the second power generating part 12. Incidentally, although not illustrated, the insulating part may be just a void. Just the presence of void may insulate the cathode current collector and the anode current collector. It is preferable that an inert gas such as argon is present in the void.

FIG. 6A is a schematic plan view explaining the cathode in the present disclosure; for example, it corresponds to a plan view when the cathode (cathode layer, cathode current collector, and cathode tab) in FIG. 1 is observed from the bottom side of the drawing. Meanwhile, FIG. 6B is a schematic plan view explaining the anode in the present disclosure; for example, it corresponds to a plan view of the anode (anode layer, anode current collector, and anode tab) in FIG. 1 is observed from the upper side of the drawing. Here, as shown in FIG. 6A and 6B, the width of cathode tab 30 is regarded as W₁, the width of cathode current collector 20 is regarded as W₂, the width of cathode layer 1 is regarded as W₃, the width of anode tab 50 is regarded as W₄, the width of anode current collector 40 is regarded as W₅, and the width of anode layer 3 is regarded as W₆. Also, for example, the ratio of W₁ to W₂ is expressed as W₁/W₂.

The value of W₁/W₂ may be 0.5 or more, and may be less than 0.5. In the former case, the value of W₁/W₂ may be 0.6 or more, may be 0.8 or more, and may be 1. In the latter case, the value of W₁/W₂ may be 0.45 or less, and may be 0.35 or less. Incidentally, in the latter case, the value of W₁/W₂ is, for example, 0.1 or more, and preferably 0.25 or more. Meanwhile, the value of W₄/W₅ may be 0.5 or more, and may be less than 0.5. The preferable range of W₄/W₅ is the same as the preferable range of W₁/W₂.

The value of W₃/W₂ is, for example, 0.8 or more, may be 0.9 or more, and may be 1. The larger the value of W₃/W₂ is, the more easily energy density may be improved. Meanwhile, the preferable range of W₆/W₅ is the same as the preferable range of W₃/W₂.

In the present disclosure, the total of the width of cathode tab and the width of anode tab may be the width of the cathode layer or more. In other words, it may be (W₁+W₄)≥W₃. In the same manner, in the present disclosure, the total of the width of cathode tab and the width of anode tab may be the width of the anode layer or more. In other words, it may be (W₁+W₄)≥W₆. Also, in the present disclosure, the width of the cathode tab may be the width of the cathode layer or more. In other words, it may be W₁≥W₃. In the same manner, in the present disclosure, the width of the anode tab may be the width of the anode layer or more. In other words, it may be W₄≥W₆.

In the present disclosure, the cathode tab and the anode tab may be arranged so as to overlap at least partially in a plan view, and may be arranged not to overlap in the plan view. In the former case, the width of the cathode tab and the anode tab may be easily set to be large; thus, the concentration of electrode reaction around the tabs may be inhibited. On the other hand, in the latter case, the short circuit of the cathode tab and the anode tab may be easily prevented.

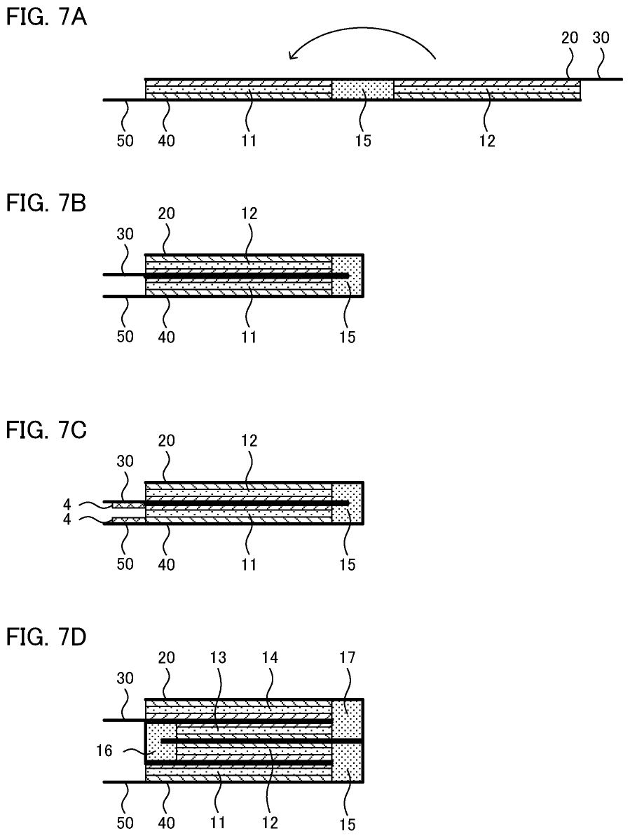

FIGS. 7A to 7D are schematic cross-sectional views illustrating the all solid state battery in the present disclosure in more simplified style. FIG. 7A shows the battery prior to forming the bend structure, and FIG. 7B shows the battery after forming the bend structure.

In the present disclosure, a short circuit preventing part may be formed on the surface of at least one of the cathode tab and the anode tab. For example, in FIG. 7C, short circuit preventing part 4 that prevents short circuit is formed on the surface of the cathode tab 30 and the anode tab 50 respectively. In particular, it is preferable that the short circuit preventing part is formed when the cathode tab and the anode tab are arranged so as to overlap at least partially in a plan view. Also, the short circuit preventing part preferably contains, for example, the same material as of the above described insulating part.

In the present disclosure, the power generating element may include a plurality of the insulating part. For example, in FIG. 7D, the bend of three of the insulating part 15, 16, and 17 forms a bend structure in which the first power generating part 11, the second power generating part 12, the third power generating part 13, and the fourth power generating part 14 are stacked in the thickness direction. The number of the insulating part may be odd number, and may be even number.

The power generating element in the present disclosure may include a plurality of the power generating unit. Also, it may have the structure in which the plurality of the power generating units (cathode layer, solid electrolyte layer, and anode layer) are stacked in the thickness direction. Further, the plurality of the power generating units may be connected to each other in parallel, and may be connected to each other in series.

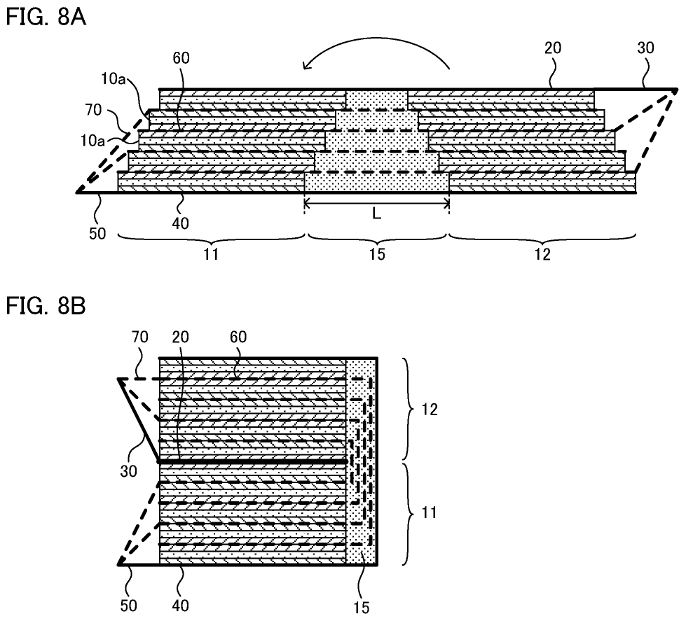

FIGS. 8A and 8B are schematic cross-sectional views illustrating an all solid state battery in which the plurality of the power generating units are connected to each other in parallel (monopolar-type stacked battery); FIG. 8A shows the battery prior to forming the bend structure, and FIG. 8B shows the battery after forming the bend structure. As shown in FIG. 8A, in the first power generating part 11 and the second power generating part 12, a plurality of power generating units 10a including a cathode layer, a solid electrolyte layer, and an anode layer, are respectively stacked. Intermediate current collector 60 is arranged between the adjacent power generating units 10a, the intermediate current collector 60 is connected to cathode tab 30 or anode tab 50 via intermediate tab 70, so as the connection is in parallel. Also, as shown in FIG. 8A, length L of each of the insulating part 15 in the plurality of the power generating unit 10a preferably increases along with the thickness direction. The reason therefor is that as shown in FIG. 8B, stress concentration when the insulating part 15 is bent may be relaxed.

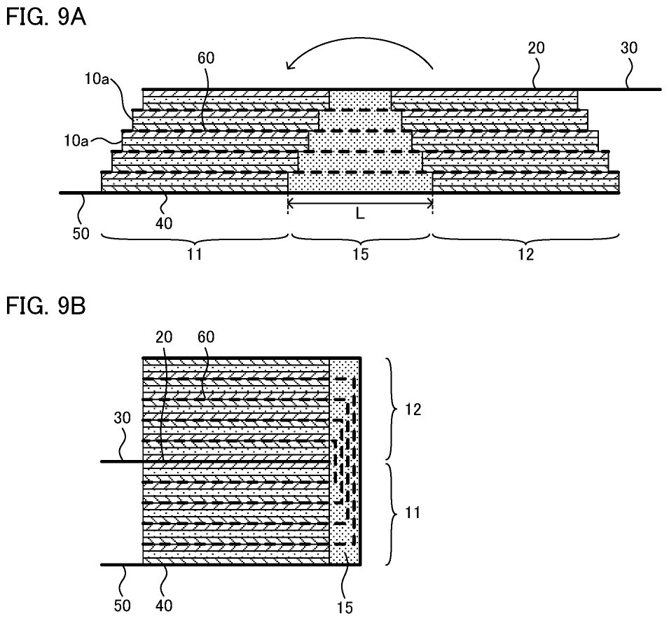

FIGS. 9A and 9B are schematic cross-sectional views illustrating an all solid state battery in which the plurality of the power generating units are connected to each other in series (bipolar-type stacked battery); FIG. 9A shows the battery prior to forming the bend structure, and FIG. 9B shows the battery after forming the bend structure. As shown in FIG. 9A, in the first power generating part 11 and the second power generating part 12, a plurality of the power generating units 10a including a cathode layer, a solid electrolyte layer, and an anode layer, are respectively stacked. Intermediate current collector 60 is arranged between the adjacent power generating units 10a. Also, as shown in FIG. 9A, length L of each of the insulating part 15 in the plurality of the power generating unit 10a preferably increases along with the thickness direction. The reason therefor is that as shown in FIG. 9B, stress concentration when the insulating part 15 is bent may be relaxed.

2. Member of All Solid State Battery

The all solid state battery comprises a power generating element, a cathode current collector, a cathode tab, an anode current collector, and an anode tab. The power generating element comprises a cathode layer, an anode layer, and a solid electrolyte layer formed between the cathode layer and the anode layer, as a power generating unit.

(1) Cathode Layer

The cathode layer is a layer that contains at least a cathode active material. Also, the cathode layer may contain at least one of a solid electrolyte, a conductive material, and a binder, as required.

Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li₄Ti₅O₁₂, and Li(Ni_{0.5}Mn_{1.5})O₄; and an olivine type active material such as LiFePO₄, LiMnPO₄, LiNiPO₄, and LiCoPO₄.

Examples of the solid electrolyte may include an inorganic solid electrolyte such as a sulfide solid electrolyte, an oxide solid electrolyte, a nitride solid electrolyte, and a halide solid electrolyte. Examples of the conductive material may include a carbon material. Examples of the carbon material may include a particulate carbon material such as acetylene black (AB) and Ketjen black (KB); and a fiber carbon material such as a carbon fiber, carbon nanotube (CNT), and carbon nanofiber (CNF). Examples of the binder may include a rubber-based binder such as butylene rubber (BR) and styrene butadiene rubber (SBR); and a fluorine-based binder such as polyvinylidene fluoride (PVDF).

The thickness of the cathode layer is, for example, 0.1 μm or more and 1000 μm or less. Examples of the method for forming the cathode layer may include a method of pasting and drying a slurry containing at least the cathode active material and a dispersion medium.

(2) Anode Layer

The anode layer is a layer that contains at least an anode active material. Also, the anode layer may contain at least one of a solid electrolyte, a conductive material, and a binder, as required.

Examples of the anode active material may include a carbon active material, a metal active material, and an oxide active material. Examples of the carbon active material may include graphite, hard carbon, and soft carbon. Examples of the metal active material may include In, Al, Si, Sn, and an alloy at least including these. Examples of the oxide active material may include Nb₂O₅, Li₄Ti₅O₁₂, and SiO.

The solid electrolyte, the conductive material, and the binder to be used in the anode layer are in the same contents as those described in “(1) Cathode layer” above; thus, the descriptions herein are omitted.

The thickness of the anode layer is, for example, 0.1 μm or more and 1000 μm or less. Examples of the method for forming the anode layer may include a method of pasting and drying a slurry containing at least the anode active material and a dispersion medium.

(3) Solid Electrolyte Layer

The solid electrolyte layer is a layer arranged between the cathode layer and the anode layer. The solid electrolyte layer contains at least a solid electrolyte, and may contain a binder as required. The solid electrolyte and the binder are in the same contents as those described in “(1) Cathode layer” above; thus, the descriptions herein are omitted. The thickness of the solid electrolyte layer is, for example, 0.1 μm or more and 1000 μm or less. Examples of the method for forming the solid electrolyte layer may include a method of compression-molding the solid electrolyte.

(4) Current Collector and Tab

The all solid state battery in the present disclosure comprises a cathode current collector, a cathode tab connected to the cathode current collector, an anode current collector, and an anode tab connected to the anode current collector.

The material of the cathode current collector and the cathode tab may be the same and may be different from each other. In the former case, the cathode current collector and the cathode tab are preferably continuously formed. Examples of the material of the cathode current collector may include SUS, aluminum, nickel, iron, titanium, and carbon. There are no particular limitations on the thickness of the cathode current collector.

The material of the anode current collector and the anode tab may be the same and may be different from each other. In the former case, the anode current collector and the anode tab are preferably continuously formed. Examples of the material of the anode current collector may include SUS, copper, nickel, and carbon. There are no particular limitations on the thickness of the anode current collector.

(5) All Solid State Battery

The all solid state battery in the present disclosure is preferably a battery in which metal ions conduct. Examples of the metal ion may include an alkali metal ion and an alkali earth metal ion. Above all, the all solid state battery in the present disclosure is preferably an all solid lithium battery. Also, the all solid state battery in the present disclosure may be a primary battery and may be a secondary battery, but preferably a secondary battery among them so as to be repeatedly charged and discharged and useful as a car-mounted battery for example. The all solid state battery in the present disclosure may have an outer packaging for storing the cathode current collector, the power generating element, and the anode current collector.

3. Method for Producing All Solid State Battery

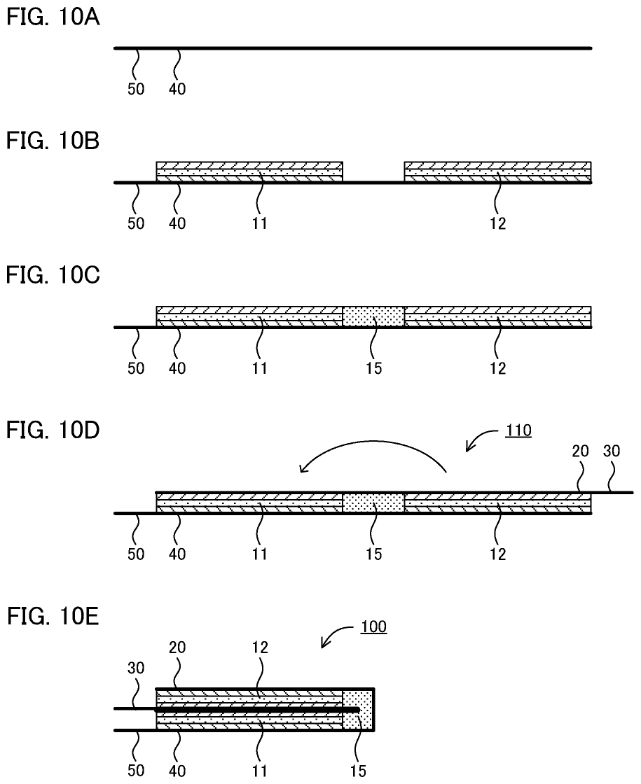

FIGS. 10A to 10E are schematic cross-sectional views explaining an example of the method for producing the all solid state battery in the present disclosure. In FIGS. 10A to 10E, first, anode current collector 40 and anode tab 50 are prepared (FIG. 10A). Next, first power generating part 11 and second power generating part 12 are formed on one surface of the anode current collector 40 (FIG. 10B). Next, insulating part 15 is formed between the first power generating part 11 and the second power generating part 12 (FIG. 10C). Next, cathode current collector 20 and cathode tab 30 are arranged on one surface of the first power generating part 11, the second power generating part 12, and the insulating part 15 (FIG. 10D). Thereby, battery stacked body 110 is obtained. Next, the insulating part 15 in the battery stacked body 110 is bent to form the bend structure in which the first power generating part 11 and the second power generating part 12 are stacked in the thickness direction (FIG. 10E). Thereby, all solid state battery 100 is obtained.

In this manner, the present disclosure may also provide a method for producing an all solid state battery, the all solid state battery being the above described all solid state battery, the method comprising steps of: a preparing step of preparing a battery stacked body provided with the power generating element including the first power generating part, the second power generating part, and the insulating part formed between the first power generating part and the second power generating part; and a bending step of bending the insulating part in the battery stacked body to form the bend structure.

There are no particular limitations on the method for preparing the battery stacked body, and a known arbitrary method may be adopted. Also, there are no particular limitations on the method for bending the insulating part.

The present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### REFERENCE SIGNS LIST

1 cathode layer
2 solid electrolyte layer
3 anode layer
10 power generating element
11 first power generating part
12 second power generating part
15 insulating part
20 cathode current collector
30 cathode tab
40 anode current collector
50 anode tab
100 all solid state battery

What is claimed is:

1. An all solid state battery comprising:
a cathode current collector;
a cathode tab connected to the cathode current collector;
an anode current collector;
an anode tab connected to the anode current collector; and
a power generating element formed between the cathode current collector and the anode current collector; wherein
the power generating element comprises a first power generating part, a second power generating part, and an insulating part;
the first power generating part and the second power generating part respectively comprises a power generating unit including a cathode layer, a solid electrolyte layer, and an anode layer;
the all solid state battery has bend structure in which the first power generating part and the second power generating part are stacked in a thickness direction due to a bend of the insulating part;
both of the cathode tab and the anode tab are arranged at a same side of the all solid state battery; and
when the bend structure is developed to a plan structure, the cathode tab and the anode tab are located in a diagonal relationship.

2. The all solid state battery according to claim 1, wherein a total of a width of the cathode tab and a width of the anode tab is a width of the cathode layer or more.

3. The all solid state battery according to claim 1, wherein a total of a width of the cathode tab and a width of the anode tab is a width of the anode layer or more.

4. The all solid state battery according to claim 1, wherein the power generating element has a structure in which a plurality of the power generating unit is stacked in a thickness direction.

5. The all solid state battery according to claim 4, wherein the plurality of the power generating element is connected to each other in parallel.

6. The all solid state battery according to claim 4, wherein the plurality of the power generating element is connected to each other in series.

7. The all solid state battery according to claim 4, wherein, when the bend structure is developed to a plan structure, a length of each of the insulating part in the plurality of the power generating element increases along with the thickness direction.
